(19) United States
(12) Patent Application Publication
(10) Pub. No.: US 2021/0174647 A1
(43) Pub. Date: Jun. 10, 2021

(54) Tennessee Hold 'Em® Poker Tournaments

(71) Applicant: Scott Arthur Hill, London (GB)

(72) Inventor: Scott Arthur Hill, London (GB)

(21) Appl. No.: 16/706,690

(22) Filed: Dec. 7, 2019

(51) Int. Cl. G07F 17/32

(52) U.S. Cl. CPC G07F 17/3293; G07F 17/3262; G07F 17/3276; G07F 17/3209

(57) ABSTRACT

An innovative method of playing a modified poker game with seven related variations featuring a novel method of tournament mechanics, through an electronic device or in a casino, known as “Tennessee Hold 'Em® Tournaments”, which promotes strategic decision making and greater player participation is defined. Three to nine players are permitted per table. Three players sitting to the left of the Dealer (Button) furnish blind bets. Five phases of card distribution and progressively increasing betting rounds are defined. After the third card distribution, players decide whether to hold all hole cards, or discard one or two hole cards. Next, all discards are revealed, giving players insight into opponents' hands. Players choosing to hold 4 hole cards are excluded from using the fourth, final community card. Players choosing to hold 5 hole cards are excluded from using the third and fourth community cards. Eliminating complex ‘side pots’, an innovative method of “loaning” additional chips, known as ‘overdrawn chips’ (ODC) allows players who do not have enough chips to continue betting and complete in that hand, providing a last chance to recover or be eliminated. The Tournament is finished when 2 players remain. Winner and runner up chip counts are totalled, and the winner's chip count is divided by the total chip count to determine the percentage of the Tournament Pot awarded to the winner. Remainder of the Tournament Pot is awarded the runner up.

### CROSS-REFERENCE TO RELATED APPLICATIONS

Not Applicable

### STATEMENT REGARDING FEDERALLY SPONSORED RESEARCH OR DEVELOPMENT

Not Applicable

### COMPUTER PROGRAM LISTING COMPACT DISC APPENDIX

Not Applicable

### BACKGROUND of the INVENTION

In both online and real world Poker, popular games, Texas Hold 'Em and Omaha have inherent drawbacks which are built into the game mechanics and betting structure. Research reveals that 50 to 70% of all players fold at the start of any hand in Texas Hold 'Em. Players report frustration at being forced to fold so frequently. Players have a much lower participation rate than in any other casino or card game. This low participation rate is detrimental for players as well as the ‘house’ (licensed poker room or casino). With thorough analyses of Texas Hold 'Em available ubiquitously, players play ‘by the book’, allowing no opportunities for any creative strategic play (other than bluffing). In both Texas Hold 'Em and Omaha, ‘Pot Limit’ and ‘No Limit’ betting allows players with a large chip count to ‘bully’ players who are less well endowed. This is unpopular with a majority of players. In Omaha, players are dealt 4, personal use ‘hole cards’. If a player is dealt 3 or 4 of a Kind, they must still discard 2 cards, meaning they will be forced to throw away their high ranking hand. As an overview, current popular Poker has limited potential for strategic card play, limiting positive frontal lobe brain stimulation. The game mechanics and betting structure of Tennessee Hold 'Em© Poker Tournaments offer a resolution to these limitations and more, focussing on increased participation, advanced decision making, sharp observation, and innovative bluffing with a progressive, flexible betting structure. In 2019, confidential meetings with the Kahnawake and Pechanga Gaming Commissions (CA) covered all aforementioned topics, indicating that this invention has genuine potential for benefitting both the iGaming community and the tribes as a whole.

### BRIEF SUMMARY of the INVENTION

“Tennessee Hold 'Em® Poker Tournaments” employs 7 related innovative variations of Poker with an integral, original method of betting to create a new form of Poker tournament that benefits players and licensed Poker operators in the real World and on the internet. Seven variations of the “Tennessee Hold 'Em” game are defined. Each variation follows similar rules, regarding named rounds of dealing, betting, and card shedding. All variations share the same integral progressive betting system. Since each hand unfolds progressively, more players stay in the hand longer. Because more players have higher ranking hands than in Texas Hold 'Em, more players compete for the pot in the showdown. Game mechanics allow players to use an innovative technique of hand-building, choosing to discard 1 or 2 hole cards (depending upon the game variation selected) or to hold all hole cards, increasing strategic decision making. Discards, known as ‘Men Overboard’ are revealed, allowing opponents insight into other players' hands, as well as offering alternative forms of bluffing.

All Figures depict default tournament variation, known as “Tennessee Riverboat (223)”. A 52, fifty two card deck is employed, including 4 suits, Hearts, Diamonds, Clubs and Spades, with 13, thirteen, ranked cards in each suit. Variations Summary: All variations follow the conventional hand rankings in the game of Poker. All variations are for 3 to 9 players. Each variation has a 3 digit reference number, defined by the number of cards distributed in the first 3 rounds of dealing, consisting of:

1st Card Distribution=First digit: ‘Hole Cards’=(1, 2, or 3 cards),
2nd Card Distribution=Second digit: ‘The Launch’=(2 community cards in all versions),
3rd Card Distribution=Third digit: ‘The Boat’=(1, 2, 3, or 4 cards)

### (1) “Tennessee Riverboat (223)”=5 Hole Cards (Default Variation 1)

### (2) “Tennessee Gambler (222)”=4 Hole Cards

### (3) “Tennessee Hustler (322)”=5 Hole Cards

### (4) “Tennessee Big Hole (321)”=4 Hole Cards

### (5) “Tennessee Red Dog (124)”=5 Hole Cards

### (6) “Tennessee Slow Hand (123)”=4 Hole Cards

### (7) “Tennessee Steamer (421)”=5 Hole Cards

The primary objectives of this invention are to stimulate greater participation and encourage creative strategic decision making (stimulating positive brain function) within the established Poker community. Additionally, using an electronic processor with an RNG, (Random Number Generator) to shuffle, clone and deal the cards, a genuine Skill Poker version of Tennessee Hold 'Em® Poker Tournaments has been created. Players play asynchronous matches, where 2 human players must try to outwit AI Robot opponents. Match players must play a series of identical hands. The player with the greater chip count at the end of this series of hands (or entire Tournament) has played their cards more skilfully, and so is declared the Winner. The primary objective of Tennessee Hold 'Em® Skill Poker Tournaments is to create a ‘pure’ form of Poker Championship, where multiplayer tournament winners can genuinely claim to be the best players in the World. Tennessee Hold 'Em® Skill Poker Tournaments also offer a strategic game which appeals to the growing skill gaming market worldwide.

### BRIEF DESCRIPTION of the SEVERAL VIEWS of the DRAWING: FIGS. 1-13

FIG. 1 (Page 46): Table Felt Design, Player and Dealer Seating Positions:

D=Dealer Seating Position. 1, 2, 3, 4, 5, 6, 7, 8, 9=Player seating positions

The center of the table has four shaded areas which are labelled, where the Dealer will place four community cards face up during each hand. Second card distribution=LAUNCH. Fourth card distribution=TURN. Fifth card distribution=RIVER. For real world tournaments, community card positions are labelled on both sides, so players sitting on either side of the table can clearly see the community card labelling.

Raise Indicators: In front of the dealer position in real world tournaments, the table has nine shaded circles, which represent the nine player seating positions. When a player raises, the Dealer places a small disc adjacent to the number corresponding to that player thus recording the number of raises made by each player. Maximum number of raises per player=the number of the Betting Round. For example, 4 raises are permitted per player in Betting Round 4. (See Betting, Part III)

FIG. 2 (Page 47): Dealer Button, Position of ‘Blind’ Bets and Chip Distribution:

B=Dealer Button indicates which player will be last to receive cards. That player is also last to act in Betting Rounds 2, 3, 4 and 5. The Dealer Button moves in a clockwise direction to player 1 for the second hand, and then on to player 2 for the third hand, etc . . . .
OB=‘Opening Blind’=½ the ‘Small Blind’. Player 1 posts the ‘Opening Blind’.
SB=‘Small Blind’=½ the ‘Big Blind’. Player 2 posts the ‘Small Blind’.
BB=‘Big Blind’=4×‘Opening Blind”. Player 3 posts the ‘Big Blind’.
Player 4 is the first to act in Betting Round 1.
Player 1 is the first to act in Betting Rounds 2 though 5.
If Player 1 folds, Player 2 will be the first to act in subsequent betting rounds.

Chip Markers: Five chip denominations are provided to each Player as depicted in FIG. 2. These five chip denominations are 25 units, 50 units, 100 units, 500 units, 1000 units. For example: At start of Tournament play, each Player holds a 20,000 unit chip total. (4×25u)+(6×50u)+(16×100u)+(16×500u)+10×1000u)=20,000 units. Note: If time is limited, at start of play, 10,000 units may be distributed to each player for shorter duration Tournaments.

FIG. 3 (Page 48): First Card Distribution, ‘Hole Cards’:

Two personal ‘Hole Cards’ are distributed to each player. ‘Hole Cards’ are defined as cards that each individual player holds and views privately. ‘Hole Cards’ may be used exclusively by that player to create their best ranking 5 card poker hand.

FIG. 4 (Page 49): First Card Distribution, Players view ‘Hole Cards’:

Betting Round 1 takes place. Action begins with Player 4. Maximum bet or Raise=100u per player. One raise is permitted per player.

FIG. 5 (Page 50): 2nd Card Distribution—‘The Launch’—Dealer deals 2 ‘community’ cards:

The Dealer positions the first and second ‘Community Cards’ in the centre of the table where the rectangles labelled “LAUNCH” are indicated. Betting Round 2 takes place. Player 1 is first to act in Betting Round 2. If Player 1 folds, then the next Player sitting in a clockwise direction who has not folded, starts the betting. This principle applies to all subsequent rounds of betting. In Betting Round 2, Maximum bet or Raise=200u per player. Two raises are permitted per player.

FIG. 6 (Page 51): ‘The Boat’—Dealer distributes 3 more Hole Cards to each player:

1-9: Dealer (Button position) deals 3 additional Hole Cards.

FIG. 7 (Page 52): Players view all 5 Hole Cards, aka, ‘The Boat’:

Each Player now holds 5 ‘hole cards’. Betting Round 3 takes place on ‘The Boat’. Maximum bet or raise=300u per player. Three raises are permitted per player. Note: In Tennessee Hold 'Em variations (223), (124), (322) and (421) each player holds 5 ‘hole cards’. In variations (222), (123) and (321), each player holds 4 ‘hole cards.

FIG. 8 (Page 53): ‘Men Overboard’—Players may discard up to two hole cards, or ‘stick’ (discard zero hole cards).

Dealer calls for ‘Men Overboard’. Now Players may discard if they wish. Example Depicted: Players 4 and 8 choose to ‘stick’ with the 5 ‘hole cards’ they have been dealt.

Note: Any player choosing to ‘stick’ with 5 hole cards may use neither the third community card (‘the Turn’), nor fourth community card (‘the River’) in their best 5 cards (of 7 allowed cards) poker hand. Players 3, and 6 discard one hole card and place it face down on the table. Players 1, 2, 5, 7 and 9 discard two hole cards and place them (in front of each player's respective seating position) face down on the table.

FIG. 9 (Page 54): ‘Men Overboard’ Discards are Revealed:

When all players have completed discarding or chosen to stick, the Dealer calls for all players to “REVEAL”. Discarded “Men Overboard”, may provide insight into each player's hand, and alter the odds of players receiving a favourable ‘Turn’ or ‘River’.

FIG. 10 (Page 55): Distribution of “NO RIVER” and “NO TURN” Markers:

For Players who choose to retain all 5 hole cards: “No Turn” and “No River” markers are placed to show opponents that Players 4 and 8 have retained all five hole cards, and are permitted neither the “TURN” nor the “RIVER” community cards in their best 5 card Poker hand (of 7 allowed cards).

For Players who choose to retain 4 hole cards: ‘No River’ markers are placed to show opponents that Players 3 and 6 have retained four hole cards and are not permitted to use ‘the River’, final community card, in their best 5 card Poker hand of 7 allowed cards. To alert opponents, a marker is placed by players who are permitted “NO RIVER”.

FIG. 11 (Page 56): Fourth card distribution, ‘The Turn’—A Third ‘Community’ Card is Dealt:

The Dealer deals a third community card in the middle of the table, adjacent to ‘the Launch’. This card is known as ‘the Turn’. Betting Round 4 takes place after ‘The Turn’. Maximum bet or raise=400u per player. four raises are permitted per player.

FIG. 12 (Page 57): Final card distribution, ‘The River’—A Fourth ‘Community’ Card is Dealt:

The Dealer deals a fourth final community card in the middle of the table adjacent to ‘the Turn’. This card is known as ‘the River’. Betting Round 5 takes place after ‘The River’. Maximum bet or raise=500u per player. Five raises are permitted per player. Darkened Player positions indicate Players who have folded.

FIG. 13 (Page 58): ‘The Showdown’:

Players reveal their best 5 card Poker hands and the winner of the hand is determined. Darkened Player positions 1, 2, 4, 7, and 8 have folded in Betting Round 5. Player 5 is declared the Winner with a Full House, Ace, Ace, 9, 9, 9.

### DETAILED DESCRIPTION of the INVENTION

### Official Rules, Game Mechanics and Tournament Structure of the Strategic Poker Game Variations Collectively Known as Tennessee Hold 'Em®:

Before Play Begins, Cards are shuffled and a single card is dealt to each player face upward. Dealer Button is placed by the player with the highest ranking card for Hand 1. In case of 2 or more players having the same highest ranked card, another card is dealt. (In any electronic versions, to determine who will sit to the right of the dealer button). The player dealt the highest rank card is said to be ‘on the button’. If two or more players are dealt a card of the same rank, these players cut the cards again, etc. . . . until a winner is determined. Winner sits to the right of the dealer button. All card distributions (dealing) and betting proceed in a clockwise direction, starting with the player sitting to the left of the player on the button.

Optional Tournament Rules: “Dealer's Choice”: Before the start of each Hand, the player on the Button decides which of the 7 variations of Tennessee Hold 'Em® will be played. Hand 1 of a Tennessee Hold 'Em Tournament, begins as depicted in FIG. 2. After the first hand, the deal rotates in a clockwise direction to the next player, or in electronic versions, the dealer button moves to the next player in a clockwise direction.

### Betting Structure:

At the start of tournament play, ‘the Banker’ (in any electronic versions a digital processor, in a casino or club, a professional, employed as a Dealer, who holds a reserve of chips and directs chip winnings to the hand winner.) distributes either 10,000 units or 20,000 units in chips to each player. (5,000 units are also permitted for single hand Skill Poker Match play.

a) Similar to the system used in “Texas Hold 'Em”, but novel to “Tennessee Hold 'Em®”, players post 3 bets, before cards are dealt, known as ‘blinds’. Before every hand of ‘Tennessee Hold 'Em®’, three players post blinds before the hand begins. The player sitting to the left of dealer posts the ‘Opening Blind’, equivalent to ¼ of the ‘Big Blind’. The next player to the left (clockwise) posts the ‘Small Blind’, equivalent to ½ of the ‘Big Blind’, and the next player to the left (in a clockwise direction) posts the ‘Big Blind’, equivalent to the agreed limit of betting or raising in betting round 1. Tournament starting Blind Bets are as follows: Opening Blind=25 u, Small Blind=50 u, Big Blind=100 u
b) Once the three blinds are posted, and the first distribution of hole cards to each player is complete, the player sitting to the left of the big blind is the “first to act” and has the option of checking, betting up to the equivalent of the ‘opening blind’, or (rarely) folding. Play continues around to the button. Next the player who posted the opening blind has the option to bet (if the previous players have checked) or to see or raise the bets so far. The same applies to the player who posted the small blind, and the player who posted the big blind and is last to act. One raise is allowed per player in the first round of betting.

When betting round 1 is complete, second card distribution, known as ‘the Launch’, is dealt. The Dealer positions 2 community cards within the shaded rectangles labelled “LAUNCH” in the center of the table, The first person sitting to the left of the button (who has not folded) will be the first to act in subsequent betting rounds.

In betting round 2, maximum bet and raise=2×Big Blind (200 units). Two raises per player are permitted. In betting round 3, maximum bet and raise=3×Big Blind (300 units). Three raises per player are permitted. In betting round 4, maximum bet and raise=4×Big Blind (400 units). Four raises per player are permitted. In betting round 5, maximum bet and raise=5×Big Blind (500 units). Five raises per player are permitted.

After 6 Hands have been played, Blind Bets (and all related bets) double. For Hands 1 though 6 (inclusive) Big Blind=100 units. For Hands 7 though 12 (inclusive) Big Blind=200 units. After 12 Hands have been played, Blind Bets (and all related bets) double again. For Hands 13 though 18 (inclusive) Big Blind=400 units. After 18 Hands have been played, Blind Bets (and all related bets) double again. For Hands 19 though 24 (inclusive) Big Blind=800 units. If the tournament has not finished before 24 Hands have been played, Blind Bets (and all related bets) double again. To summarize, after every 6 Hands, Blind Bets (and all related bets during Betting Rounds 1 through 5) double, until only two players remain in the Tournament and prizes are awarded.

When any player does not have enough chips to see or raise betting in a hand, that player may request a chip bonus from the Dealer (or microchip processor in electronic versions) equivalent to one half of the original chip allotment. Thus, if the initial chip distribution was 10,000u, that player may ‘borrow’ an additional 5,000u to complete that hand. This bonus chip distribution is known as “Overdrawn Chips” (ODC). If a player using ODC loses the hand, then those chips bet in that hand are added to the hand winner's total, and the player using ODC is eliminated. Any unused ODC are returned to the Dealer (Banker). If a player using ODC wins that hand, all ODC ‘loaned’ to that player are returned to the dealer. In electronic versions, the microprocessor automatically reclaims the loaned ODC, and that player continues playing in the Tournament. Players requiring bonus ODC are permitted to borrow ODC in any hand, as long as they begin that hand with a positive chip count.

### Game Structure—Variations of Tennessee Hold 'Em®—Detailed Description:

The “Tennessee Riverboat (223)” Tournament variation is described herein. “Tennessee Riverboat (223)” is employed in official World Championship Qualifying Tournaments and is employed as default variation in electronic versions. All variations are identified by name and number. Numerical nomenclature corresponds to the the number of cards dealt in each of the first 3 rounds of dealing.

Variation 1: “Tennessee Riverboat (223)”:

(1) i: First Card Distribution, aka ‘The Hole’ (see FIG. 3): The Dealer** distributes a first single ‘hole’ card (single player, exclusive use card) to each individual player, and then distributes a second single ‘hole’ card (single player, exclusive use card) to each player. All players now hold 2 exclusive use cards that only that player can view. Note: ‘Hole card’ is defined as a single player, exclusive use card, which not visible to opponents.
** In any electronic versions, the Dealer is replaced by a graphic icon referred to as “the Button”: A dealer button (or just the “button”) is a disk that is rotated clockwise between the players. The player that is “on the button” is considered the dealer and is also the last to act in each betting round, except the first round of betting, where the player sitting to the left of (the player placing) the ‘big blind’ is the first to act.
(1) ii: All Players view their hole cards (see FIG. 4). Next, Round 1 of betting begins with the player sitting to the left of the player who furnishes the big blind, who is the “first to act”. In all rounds, betting proceeds in a clockwise direction. Each player must decide whether to check, bet, see, or raise up to the limit equal to the ‘Opening Blind’. Occasionally, Players may also fold, if they deem their hole cards are not strong enough to play. Only 1 raise per player is allowed in betting Round 1. Maximum raise equals the Big Blind, 100 units at start of play.
(1) iii: Second Card Distribution, aka “The Launch” (see FIG. 5)—The dealer distributes a second set of playing cards in the middle of the “table”, in the form of two community cards in line, face up, and these two cards, referred to as “The Launch”, may be used by any individual player to form a winning hand. ‘The Launch’ consists of 2 community cards in all variations of Tennessee Hold 'Em.
(1) iv: Betting on “The Launch”—Round 2 of betting commences with the first player sitting to the left of the dealer ‘button’ who has not folded: In betting Round 2, each player may either check (if no player bets beforehand), or bet, see or raise up to double the Big Blind (200 units at start of play), or fold. Two raises per player are allowed in betting Round 2.
(1) v: Third Card Distribution, aka “The Boat” (see FIG. 6)—The Dealer, or dealer button distributes a third ‘hole’ card to each individual player. Then distributes a fourth single ‘hole’ card to each individual player and distributes a fifth, final single ‘hole’ card to each individual player. Each player now holds five hole cards known collectively as ‘the Boat’*.
*Note: “The Boat”: Variations (223), (322), (124), and (421) are all 5 Hole Card games which have identical subsequent phases of card distribution and rounds of betting.
(1) vi: Players view their 5 hole cards, ‘the Boat’ (see FIG. 7), and betting on ‘The Boat’, Round 3 commences with the first player sitting to the left of the dealer ‘button’ who has not folded: In Betting Round 3, each player may either check (if no player bets beforehand), see, bet or raise up to three times the Big Blind (300 units at start of play), or fold. Three raises per player are allowed in Betting Round 3.
(1) vii: Discards are known as ‘Men Overboard’. Dealer declares, “Men Overboard!” (In electronic versions, a notification states “Men Overboard!”) which informs players they are now permitted to discard (shed cards). In all variations, Players must retain a minimum of 3 Hole cards. Each player must choose to either shed (discard) 1 or 2 cards from his/her 5 hole cards (“The Boat”), or choose to ‘stick’ with all 5 hole cards which have been dealt. Each player places his or her discard or discards face down on the table, or declares that he or she wants to ‘stick’ with all 5 Hole cards (see FIG. 8). (In real world tournaments, this may also be indicated by a player tapping on the table.) Any player choosing to ‘stick’ with 5 hole cards is permitted to use neither the third community card, “the Turn”, nor the fourth community card, “the River” (see FIG. 8, Players 4 and 8) in their 5 card, best ranking poker hand during the ‘showdown’.
(1) viii: The “Reveal”—The Dealer calls for players to “REVEAL” discards. (see FIG. 9) In electronic versions, all ‘Men Overboard’ are revealed automatically. When all discards have been viewed, the Dealer removes them from play. In electronic versions, discards automatically disappear after several seconds. The dealer places “No River” Markers by players holding 4 or 5 hole cards, and places “No Turn” Markers by any Player holding 5 hole cards. (see FIG. 10)
(1) ix: The “Turn”—The dealer distributes a third community playing card in the middle of the table, in line with the said 2 existing community cards, face up, and this card is referred to as the “Turn”. (see FIG. 11) The Turn may be used by any individual player to form a winning hand, except players who have chosen to hold 5 hole cards.
(1) x: Betting on the “Turn”—Betting Round 4 commences with the first player sitting to the left of the dealer ‘button’ who has not folded: In Round 4, each player may either check (if no player bets beforehand), or bet or raise up to the limit of betting Round 4 (Four times the Big Blind), or see or call the previous bet and subsequent raise or raises, or may choose to fold. Four raises per player are allowed in betting Round 4. Maximum bet equals four times the Big Blind (400 units at start of play).
(1) xi: The “River”—The dealer distributes a forth, final community playing card in the middle of the table, in line with the said 3 existing community cards, face up, and this card, referred to as the “River” (see FIG. 12), may be used by any individual player to form a winning hand, with the exception of any players choosing to ‘stick’ with 4 or 5 hole cards. In this case, said player is not permitted to use the River card in their 5 card, best ranking poker hand during the ‘Showdown’. (see (1) xiii)
(1) xii: Betting on the “River”—Betting Round 5 commences with the first player sitting to the left of the dealer ‘button’ who has not folded: In Round 5, each player may either check (if no player bets beforehand), or bet or raise up to the limit of betting Round 5 (Five times the big blind, 500 units at start of play), or see, or call the previous bet and subsequent raise or raises, or may choose to fold. In betting Round 5, five raises per player are allowed.
(1) xiii: “The Showdown” (see FIG. 13)—Showdown Rules:
In all electronic versions, players best ranking 5 card poker hands are automatically analysed and selected. There are two different procedures, depending on whether or not there was betting on the final, fifth round of betting:

a) If there was no betting on Round 5, after the River, the showdown goes in the same order as all other actions, starting left of the button and proceeding clockwise to the button. The first player still holding live cards turns them face up. Then each subsequent player can either turn his/her own cards face up, or, if he/she sees that he/she is not the winner, that player may pass them back to the dealer face down or reveal them, if they wish.

b) If there was betting in Round 5 (after the River), the last player to take an aggressive action (defined as either betting or raising) is obligated to reveal his or her cards first. Then the showdown proceeds around the table clockwise without regard to where the button is. As in the previous paragraph, each player subsequently chooses to show his/her cards or pass them back to the dealer face down. The player with the highest ranking 5 card Poker hand (of 7 permitted cards) and all chips bet in the hand are awarded to the Winner.

Variation (2): “Tennessee Gambler (222)”=4 Hole Cards

*Note: Where indicated, see Variation 1: “Tennessee Riverboat (223)”
(2) i and (2) ii: see Variation 1: (1) i, “First card Distribution . . . ” and (1) ii—“All Players view their hole cards . . . ”
(2) iii and (2) iv: see Variation 1: (1) iii and (1) iv—(2 community cards are dealt, Betting Round 2)
(2) v: Third Card Distribution, aka “The Boat”—The Dealer, or dealer button distributes a third ‘hole’ card to each individual player. Then distributes a fourth single ‘hole’ card to each individual player. Each player now holds four hole cards known collectively as ‘the Boat’.
(2) vi: Players view their 4 hole cards, ‘the Boat’, and betting on “The Boat”, Round 3 commences with the first player sitting to the left of the dealer ‘button’ who has not folded: In betting Round 3, each player may either check (if no player bets beforehand), or bet, see or raise up to treble the Big Blind (300 units at start of play), or fold. Three raises per player are allowed in betting Round 3.
(2) vii: Discards are known as ‘Men Overboard’. Dealer declares, “Men Overboard!” (In electronic versions, a notification also states “Men Overboard!”) which informs players they are now permitted to discard (shed a card). Each player must chose to either shed (discard) 1 card from his/her 4 Hole cards (“The Boat”), or choose to ‘stick’ with all 4 Hole cards which have been dealt. Each player, places his or her discard face down on the table, or declares that he or she wants to ‘stick’. (In real world tournaments, this may also be indicated by a player tapping on the table.) Any player choosing to ‘stick’ with 4 hole cards is not permitted to use the fourth community card, the “River” in their 5 card, best ranking poker hand during the ‘showdown’.
(2) viii: See Variation 1: (1) viii. “The Dealer calls for players to ‘REVEAL’ their discards . . . ”
(2) ix: The “Turn”—The dealer distributes a third community playing card in the middle of the table, in line with the said 2 existing community cards, face up, and this card, referred to as “The Turn”, may be used by any individual player to form a winning hand.

### (2) x: See Variation 1: (1) x. “: Betting on the “Turn” . . . .

(2) xi: The “River”—The dealer distributes a forth, final community playing card in the middle of the table, in line with the said 3 existing community cards, face up, and this card, referred to as the “River”, may be used by any individual player to form a winning hand, with the exception of any players choosing to ‘stick’ with 4 hole cards. In this case, said player or players is/are not permitted to use the “River” in their 5 card, best ranking poker hand during the ‘Showdown’.

### (2) xii: See Variation 1: (1) xii: “Betting on the “River”—Betting Round 5 . . . ”

(2) xiii: “The Showdown”—Showdown Rules: (see Variation 1: (1) xiii)

Variation (3): “Tennessee Hustler (322)”=5 Hole Cards

(3) i: First Card Distribution, aka the “Hole’: The Dealer distributes a first single ‘hole’ card to each individual player, and then distributes a second single ‘hole’ card to each individual player. Next, the Dealer distributes a third single ‘hole’ card to each individual player. Each player now holds 3 exclusive use cards that only that player can view.
(3) ii: See Variation 1: (1) ii—Players view ‘the Hole’
(3) iii and (3) iv: see Variation 1: (1) iii and (1) iv—‘The Launch’: 2 community cards . . . .
(3) v: Third Card Distribution, aka “The Boat”, (FIG. 6) The Dealer, or dealer button distributes a fourth ‘hole’ card to each individual player. Then distributes a fifth single ‘hole’ card to each individual player. Each player now holds five hole cards known collectively as ‘the Boat’.
(3) vi: See Variation 1: (1) vi—Players view their 5 hole cards (‘the Boat’) . . . .
(3) vii: See Variation 1: (1) vii: ‘Men Overboard’ discards allowed.
(3) viii: See Variation 1: (1) viii: ‘Men Overboard’ are revealed.
(3) ix: See Variation 1: (1) ix: Third community card distributed, ‘the Turn’

### (3) x: See Variation 1: (1) x: Betting on the Turn, Round 4.

(3) xi: See Variation 1: (1) xi: Fourth, final community card distributed, the ‘River’.

### (3) xii: See Variation 1: (1) xii: Betting on the River, Round 5.

(3) xiii: See Variation 1: (1) xiii: “The Showdown”—Showdown Rules.

Variation (4): “Tennessee Big Hole (321)”=4 Hole Cards

### (4) i: See Variation (3) i: First Card Distribution, aka ‘The Hole’ . . . .

(4) ii: See Variation 1: (1) ii—Players view ‘the Hole’ . . . .
(4) iii: and (4) iv: See Variation 1: (1) iii and (1) iv—‘The Launch’: 2 community cards . . . .
(4) v: Third Card Distribution, aka “The Boat”—The Dealer, or dealer button distributes a fourth ‘hole’ card to each individual player. Each player now holds four hole cards known collectively as ‘the Boat’.
(4) vi: See Variation 2: (2) vi—Players view their 4 hole cards (‘the Boat’) . . . .
(4) vii: See Variation 2: (2) vii: ‘Men Overboard’—1 or zero discards allowed per player.
(4) viii: See Variation 2: (2) viii: ‘Men Overboard’ are revealed.
(4) ix: See Variation 2: (2) ix: Third community card distributed, the ‘Turn’ . . . .

### (4) x: See Variation 1: (1) x: Betting on the Turn, Round 4 . . . .

(4) xi: See Variation 2: (2) xi: Fourth, final community card distributed, the ‘River’ . . . .

### (4) xii: See Variation 1: (1) xii: Betting on the River, Round 5 . . . .

(4) xiii: See Variation 1: (1) xiii: “The Showdown”—Showdown Rules . . . .

Variation (5): “Tennessee Red Dog (124)”=5 Hole Cards

(5) i: First Card Distribution, aka the ‘Hole’: The Dealer distributes a first single ‘hole’ card (single player, exclusive use card) to each individual player. Each player now holds one exclusive use card that only that player can view.
(5) ii: See Variation 1: (1) ii—Players view ‘the Hole’ . . . .
(5) iii: and (5) iv: See Variation 1: (1) iii and (1) iv—‘The Launch’: Two community cards are dealt, Betting Round 2, aka betting on the Launch . . . .
(5) v: Third Card Distribution, aka “The Boat” (FIG. 6). The Dealer, or dealer button distributes a second hole card to each individual player and distributes another third hole card to each player. Next, the Dealer distributes a fourth ‘hole’ card to each individual player, then distributes a fifth single ‘hole’ card to each individual player. Each player now holds five hole cards known collectively as ‘the Boat’.
(5) vi: See Variation 1: (1) vi—Players view their 5 hole cards, ‘the Boat’ (FIG. 7) . . . .
(5) vii: See Variation 1: (1) vii: ‘Men Overboard’ discards allowed.
(5) viii: See Variation 1: (1) viii: ‘Men Overboard’ are revealed.
(5) ix: See Variation 1: (1) ix: Third community card distributed, the ‘Turn’ . . . .

### (5) x: See Variation 1: (1) x: Betting on the Turn, Round 4 . . . .

(5) xi: See Variation 1: (1) xi: Fourth, final community card distributed, the ‘River’ . . . .

### (5) xii: See Variation 1: (1) xii: Betting on the River, Round 5 . . . .

(5) xiii: See Variation 1: (1) xiii: “The Showdown”—Showdown Rules . . . .

Variation (6): “Tennessee Slow Hand (123)”=4 Hole Cards

(6) i: First Card Distribution, aka ‘The Hole’: The Dealer distributes a first single ‘hole’ card (single player, exclusive use card) to each individual player. Each player now holds one exclusive use card that only that player can view.
(6) ii: See Variation 1: (1) ii—Players view ‘the Hole’ . . . .
(6) iii: and (6) iv: See Variation 1: (1) iii and (1) iv—‘The Launch’: Two community cards . . . .
(6) v: Third Card Distribution, aka “The Boat” (see FIG. 3a)—The Dealer, or dealer button distributes a second ‘hole’ card to each individual player. Then distributes a third single ‘hole’ card to each individual player and distributes a fourth, final single ‘hole’ card to each individual player. Each player now holds four hole cards known as ‘the Boat’.
(6) vi: See Variation 2: (2) vi—Players view their 4 hole cards, ‘the Boat’ . . . .
(6) vii: See Variation 2: (2) vii: ‘Men Overboard’—1 discard allowed per player.
(6) viii: See Variation 2: (2) viii: ‘Men Overboard’ are revealed.
(6) ix: See Variation 2: (2) ix: Third community card distributed, the ‘Turn’ . . . .

### (6) x: See Variation 1: (1) x: Betting on the Turn, Round 4 . . . .

(6) xi: See Variation 2: (2) xi: Fourth, final community card distributed, ‘the River’ . . . .

### (6) xii: See Variation 1: (1) xii: Betting on the River, Round 5 . . . .

(6) xiii: See Variation 1: (1) xiii: “The Showdown”—Showdown Rules . . . .

Variation (7): “Tennessee Steamer (421)”=5 Hole Cards

(7) i: First Card Distribution, aka ‘The Hole’: The Dealer distributes a first single ‘hole’ card to each individual player, and then distributes a second single ‘hole’ card to each individual player. Next, the Dealer distributes a third single ‘hole’ card to each individual player. Then, Dealer distributes a fourth single hole card to each individual player. Each player now holds 4 exclusive use cards that only that player can view.
(7) ii: See Variation 1: (1) ii—Players view ‘the Hole’ . . . .
(7) iii: and (7) iv: See Variation 1: (1) iii and (1) iv—‘The Launch’: Two community cards are dealt and betting Round 2, aka betting on the Launch . . . .
(7) v: Third Card Distribution, aka “The Boat” (see FIG. 6)—The Dealer, or dealer button distributes a fifth, final single ‘hole’ card to each individual player. Each player now holds five hole cards known collectively as ‘the Boat’.
(7) vi: See Variation 1: (1) vi—Players view their 5 hole cards, ‘the Boat’ (FIG. 7), and bet on “The Boat”, betting Round 3 . . . .
(7) vii: See Variation 1: (1) vii: ‘Men Overboard’ discards allowed . . . .
(7) viii: See Variation 1: (1) viii: ‘Men Overboard’ are revealed . . . .
(7) ix: See Variation 1: (1) ix: Third community card distributed, ‘the Turn’ . . . .

### (7) x: See Variation 1: (1) x: Betting on the Turn, Round 4 . . . .

(7) xi: See Variation 1: (1) xi: Fourth, final community card distributed, ‘the River’ . . . .

### (7) xii: See Variation 1: (1) xii: Betting on the River, Round 5 . . . .

(7) xiii: See Variation 1: (1) xiii: “The Showdown”—Showdown Rules . . . .

Showdown: Hand Ranking—Rules:

Each player nominates their best 5 card Poker hand (of 7 permitted cards) are compared in ranking.

Players choosing to hold four hole cards are excluded from using ‘the River’.

Players choosing to hold 5 hole cards may not use ‘the Turn’ or ‘the River’.

Straight Flush—Any 5 card hand consisting of 5 cards of consecutive ranking with all cards of the same suit. In the rare event that two players have straight flushes with the same high card (in different suits), those players split the pot. Highest possible ranking hand is a Straight Flush, known as a Royal Flush, which is Ace High

4 of a Kind—Any 5 card hand consisting of 4 of 5 cards of the same Ranking. If two or more players have the same four of a kind, then the higher or highest fifth card kicker determines the winner.

Full House—Any 5 card hand consisting of 3 of a Kind and a Pair. If two or more players have a full house, the player with the best 3 of a Kind wins. If those 3 of a Kind are equal in rank, the player with the higher Pair wins. If 2 players have the same ranked 3 of a Kind and the same ranked Pair, those players share the pot.

Flush—Any 5 card hand consisting of 5 cards in the same suit. If two of more players have a flush, then the player with the highest card in their flush wins. If the highest cards are equal, the second highest ranked cards are compared, and so on down to the fifth card. In the rare event that 2 players have identically ranked Flushes in different suits, those players split the pot.

Straight—Any 5 card hand consisting of 5 cards of consecutive ranking. If two or more players have the same high card in their respective straights, the pot will be split between those players.

3 of a Kind—Any 5 card hand consisting of 3 cards of the same Ranking and 2 other rankings. If two or more players have the same three of a kind in their best 5 card hand, the two remaining cards, known as ‘kickers’, determine the winner. If both the kickers are also equal, the pot will be split between those players.

Two Pair—Any 5 card hand consisting of 2 matching pairs of cards of the same Ranking. If two or more players have the same two pair, then the fifth card ‘kicker’ determines the winner. If the kickers are also equal, the pot will be split between those players.

One Pair—Any 5 card hand consisting of a matching pair of cards of the same Ranking. If two or more players have the same pair, then the highest of the three remaining cards (known as kickers) determines the winner. If the highest kickers are also equal, then the second highest kickers are compared. If the second highest kickers are also equal, the third, final ‘kicker’ is compared to determine a winner. If the pair, and all 3 kickers are equal, the pot will be split between those players.

High Card—If two or more players have the same highest ranking card, then the second highest card (and so on, to the fifth card) determines the winner. If 2 or more players hold identically ranked 5 card hands, the pot will be split between those players.

### TERMS and DEFINITIONS

Banker: In a casino or club, a professional, employed as a Dealer, who holds a reserve of chips and directs chip winnings to the hand winner.

Button: The Dealer ‘Button’ is a table marker (electronic or physical) which indicates which player is ‘Dealing’ that hand. Specifically, the player sitting to the left of the ‘Button’ is the first to act in Betting Rounds 2, 3, 4 and 5 (if said player has not folded). The player sitting to the left of the ‘Button’ also provides the ‘Opening Blind’ at the start of each hand. After each hand, the ‘Button’ moves to the next player to the left of the previous Dealer. In a casino or club, a professional employee deals on behalf of the player who is ‘on the Button’.

Opening Blind (OB): Before the first card distribution, the player sitting to the left of the ‘Button’ provides an initial bet at the start of each hand. The Opening Blind is equivalent to one half of the Small Blind. The Opening Blind is equivalent to one quarter of the Big Blind.

Small Blind (SB): Before the first card distribution, the player sitting second to the left of the ‘Button’ provides an initial bet at the start of each hand. The Small Blind is equivalent to double the Opening Blind. The Small Blind is equivalent to one half of the Big Blind.

Big Blind (BB): Before the first card distribution, the player sitting third to the left of the ‘Button’ provides an initial bet at the start of each hand.

The Hole: First card distribution—1, 2, 3 or 4 (according to variation) ‘personal’ Cards are distributed to each player,

The Launch: Second card distribution. The first two community cards are revealed in the centre of the table.

The Boat: Third card distribution—1, 2, 3 or 4 (according to variation) ‘personal’ Cards are distributed to each player.

Men Overboard: Dealer Declares that players are now permitted to discard one or two cards from their ‘Boat’ or to ‘stick’ with (retain) all hole cards dealt.

The Turn: Fourth card distribution—The third community card is revealed in the centre of the table.

The River: Fifth card distribution—The fourth community card is revealed in the centre of the table.

The Showdown: At the end of betting Round 5, players reveal their best 5 card Poker hand (of 7 permitted cards) and the winner is declared.

Overdrawn Chips (ODC): A novel method of chip distribution, whereby any player who does not have enough chips to cover the bet or raises during any hand of the Tournament, will be credited with half the initial chip distribution in bonus chips, known as Overdrawn Chips.

“No River”: Disc marker indicating a player is holding 4 or 5 hole cards and is therefore, not permitted to use the River in their best 5 of 7 cards Poker Hand.

“No Turn”: Disc marker indicating a player is holding 5 hole cards and is therefore, not permitted to use the Turn in their best 5 of 7 cards Poker Hand.

### DRAWINGS

1: An unique method of playing a modified poker game as a tournament competition with a nominated dealer (professional employee if played in a casino or gambling club using a dealer button disc marker, or dealer ‘button’ graphic in any electronic versions) is claimed on a circular, or polygonal, or elliptical card table, or through an electronic device with a graphic representation of a card table comprising a series of named rounds of dealing, with specific numbers of cards, which define seven related variations of said poker game and said tournament competition rules; wherein said dealer performs the following, or said electronic device is coded with instructions and executed by a processor to perform all of the following:
I. Provide a 52 card deck of standard playing cards with 13 ranks in each of 4 suits, each card having a value which may contribute to a winning 5 card poker hand.
II. Set a parameter to rotate the Dealer ‘Button’ to the next player in a clockwise position each time a new hand begins.
III. Indicate (and automatically furnish in electronic versions) 3 Blind Bets for the first 3 players sitting to the left of the ‘Button’.
IV. Limit maximum betting and allowed raises per player in each of five progressive rounds of betting.
V. Distribute a first single ‘hole’ card or set of ‘hole’ (single player, exclusive use) cards (one, two, three or four cards, depending upon the game variation played) to each individual player playing the poker game; the first set of playing cards comprising cards from said card deck and having a card value which can only be used by each individual holding said ‘hole’ cards distributed in a manner so that only individual players receiving the cards can view;
VI. Distribute a second set of playing cards in the middle of the table comprising two community cards, face up, collectively known as ‘the Launch’; the second set of playing cards comprising cards from said card deck and having a card value which all players can view and use to form a winning hand;
VII. Distribute a third set of playing cards by distributing additional hole cards (one, two, three or four cards, depending upon the game variation played), in a manner so that only individual players receiving said cards can view; These 4 or 5 hole cards, depending upon the game variation played, will be collectively known as “The Boat”.
VIII. Provide each player with the option to hold or discard (shed) selected hole cards, collectively known as “Men Overboard!”. Said discards are placed face down on the table.
IX. Expose discarded hole cards, as nominated by each player in turn, depending upon the poker game variation selected. Specifically, reveal each player's discards. In any real world tournament hand, dealer asks all players to reveal their discards by turning them face up.
X. Remove exposed, “Men Overboard” hole cards from the Table.
XI. Place “No River” and “No Turn” Disc Markers indicating players choosing to hold more than 3 hole cards.
XII. Distribute and display a third playing card in the middle of the table, as known as “the Turn”, adjacent to, and to the left of “the Launch”, to form three community cards; said third community playing card comprising cards from the playing deck and having a card value in which each individual player can view and use to form a winning hand, with the exception of any player choosing to hold 5 hole cards, (when playing game variations whereby 5 hole cards are distributed to each player);
XIII. Distribute and display a fourth, final playing card in the middle of the table, as known as “the River”, adjacent to, and left of “the Turn” to form four community cards; said fourth community playing card comprising cards from said playing deck and having a card value in which each individual player can view and use to form a winning hand, with the exception of any player choosing to hold 4 or 5 hole cards;
XIV. Indicate which player plays next during any round of card shedding or round of betting, known as ‘turn-taking’.
XV. Provide each player with the option to bet, raise, check or fold, or to shed (discard) a card or cards, or to ‘stick’, defined as choosing to hold more than 3 hole cards, during each appropriate round of betting.
XVI. Exclude any individual player who choses to ‘stick’ with five hole cards, from using said third community playing card in the middle of said table, to form a winning hand by placing 2 discs, labelled, “No Turn” and “No River” by said player.
XVII. Exclude any individual player who choses to ‘stick’ with four or five hole cards, (depending upon the game version played) from using the said forth community playing card in the middle of the table (the River), to form a winning hand by placing a disc, labelled, “No River” by said player.
XVIII. Place a red disc marker on the Table by any player who goes ‘all-in’ and uses “Overdrawn Chips”, known as ‘ODC’. In any live casino or poker room, an oversized red disc. In any electronic versions, player avatar turns red in color.
XIX. Provide any player who goes all-in on any hand with a chip unit bonus, known as “ODC”, Overdrawn Chips, equivalent to one half of the initial tournament distribution.
XX. Retrieve “ODC” from any player who draws it and wins that hand, and remove any remaining ODC after any player drawing ODC loses said hand, and is subsequently eliminated from the Tournament.
XXI. Direct all chips bet during any given hand, (the Pot) to the Winner of that hand. In electronic versions, chip calculations are automatic and Winner's chip count is credited automatically.
XXII. Perform all of the above within the official tournament rules of said poker game and variations, known collectively as “Tennessee Hold 'Em®”.

2: An innovative method of placing ‘blind’ bets is claimed, using a nominated dealer or computer coding, application, or software to determine which players place 3 different blind bets: All variations of said poker game share the placement of three blind bets before each hand begins, with the benefit that,
this invention improves upon traditional placement of 2 blind bets by impelling a third player to have a vested interest in the hand before it starts. The first blind bet, known as the ‘Opening Blind’ (OB) is placed by the player sitting to the left of the Dealer or Dealer Button. The second blind bet, known as the ‘Small Blind’ (SB) is placed by the second player sitting to the left of the Dealer or Dealer Button. The Small Blind equals double the Opening Blind. (2OB=SB) The third blind bet, known as the ‘Big Blind’ (BB) is placed by the third player sitting to the left of the Dealer or Dealer Button. The Big Blind equals double the Small Blind. The Big Blind therefore equals four times the Opening Blind. (4OB=2SB=BB) Example: If OB=25 units, SB=50 units, and BB=100 units.

3: An innovative method of game mechanics, known as “Men Overboard” is claimed, using a nominated dealer or computer coding, application or software emulating said novel method of game mechanics, whereby players are notified that they are permitted to shed 1 or 2 personal ‘hole’ cards, or to retain all hole cards, with related rules which allow or exclude players use of the final two community cards, known as the “Turn” and the “River”, providing players with ‘hand-building’, strategic, decisive opportunities which stimulate positive frontal lobe brain activity, and introduce a greater skill element than that which is featured in current popular forms of Poker, specifically as follows:
I. Once “Men Overboard” is notified, all players may shed a card or 2 cards (in 5 hole card variations), or ‘stick’, whereby, In electronic versions, a timer counts down (example: 20 seconds) to allow players to discard, and discarded cards are placed on the table in front of each player, face down, without revealing them to the other players, until all players have discarded or indicate that they wish to ‘stick’.

4: Subsequent to said sequential card distribution and card shedding, aforementioned in CLAIM 1, an innovative method of revealing shed cards is claimed, whereby, after cards are shed by each player, a nominated dealer or computer coding, application, or software emulating said dealer, calls for players to ‘reveal’ their discards, (in electronic versions, shed cards are automatically revealed and removed after 15 seconds) allowing players insight into each opponent's hand, and providing an innovative method of bluffing, which has not existed previously in established Poker variations, specifically as follows:
I. In electronic versions, all discards on the Table are revealed automatically by turning them face up, or In real world casino or club based Tournaments, Dealer tells Players to ‘Reveal’ all discards.
II. When discards have been revealed and viewed, the dealer removes them from the table, and Dealer places “No River” marker discs adjacent to players who hold 4 or 5 hole cards, and “No Turn” marker discs adjacent to players who choose to hold 5 hole cards.
III. The “No River” disc marker indicates any players that are not permitted to use the fourth, final community card, known as ‘the River’ in their best 5 of 7 permitted cards Poker hand at the Showdown. The “No Turn” disc marker indicates any players that are not permitted to use the third community card, known as ‘the Turn’ in their best 5 of 7 permitted cards Poker hand at the Showdown.

5: In order to increase player participation, an innovative, progressive method of betting is claimed, which is integrated within the structure of tournament play, whereby, a nominated dealer or computer coding, application or software is utilised to calculate and control betting during each hand as follows:
I. In Hand 1, after the first card distribution (“the Hole”) is completed, in Betting Round 1, the Big Blind=100 units. Also, in betting round 1, maximum bet or raise equals the Big Blind (BB), and one raise is allowed per player in the first round of betting. In betting round 2, maximum bet and raise=2×Big Blind=200 units, and 2 raises per player are permitted. In betting round 3, maximum bet and raise=3×Big Blind=300 units, and 3 raises per player are permitted. In betting round 4, maximum bet and raise=4×Big Blind=400 units, and 4 raises per player are permitted. In betting round 5, maximum bet and raise=5×Big Blind=500 units, and 5 raises per player are permitted.
II. Blinds and all related bets double every seventh hand, after Hands 6, 12, 18, 24, 30, etc. . . . . For example: Big Blind=100 units during Hands 1-6. Big Blind=200 units during Hands 7-12. Big Blind=400 units during Hands 13-18. Big Blind=800 units during Hands 19-24. Big Blind=1600 units during Hands 25-30, etc . . . .
Notes on live Tournaments—In real world (casino or club based) tournaments, players place chips wagered on the current hand in front of their stacked remaining chips, allowing the Dealer and remaining players to track how much each player has bet during any round of betting. When a player folds, that player places his/her chips bet previously on that hand, on top of their folded, face down hole cards, on the table in front of their seating position. This applies to all players who fold during any phase until the end of the hand, when the dealer collects all chips bet, and awards them to the winner. In the rare case of a tie, the pot is split equally. Dealer collects all cards on the table. Dealer button moves to the next player in a clockwise direction and the next hand begins. In electronic versions these actions are performed by a microprocessor.

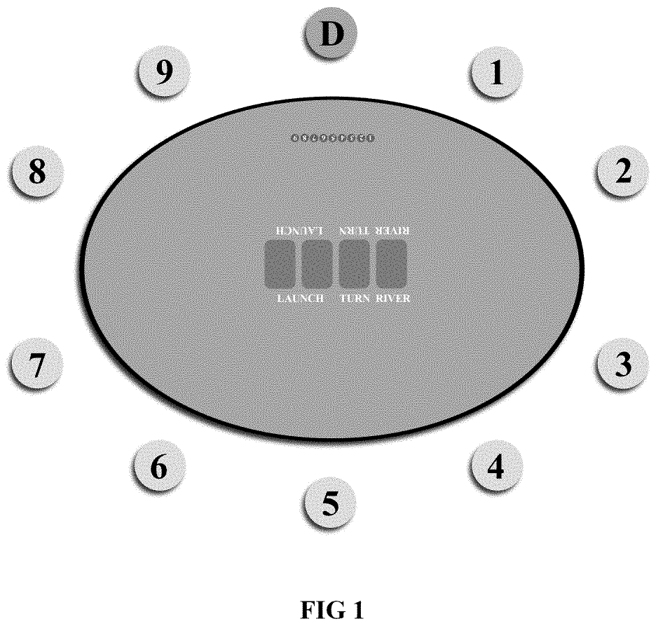

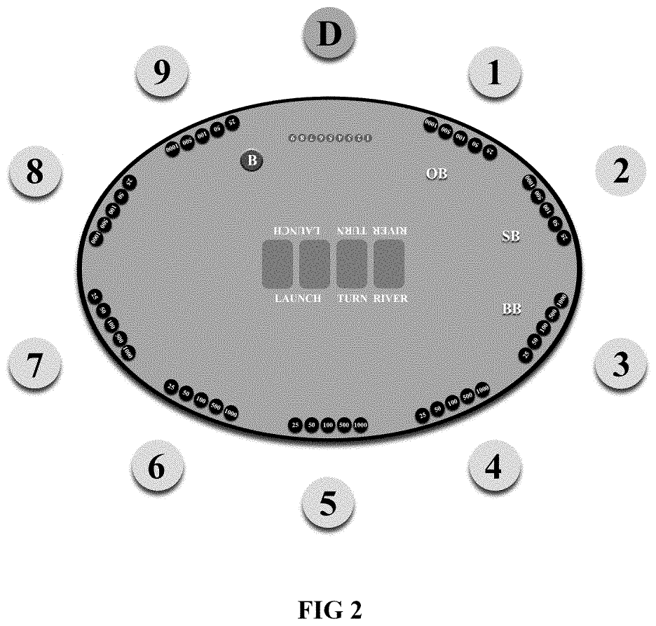

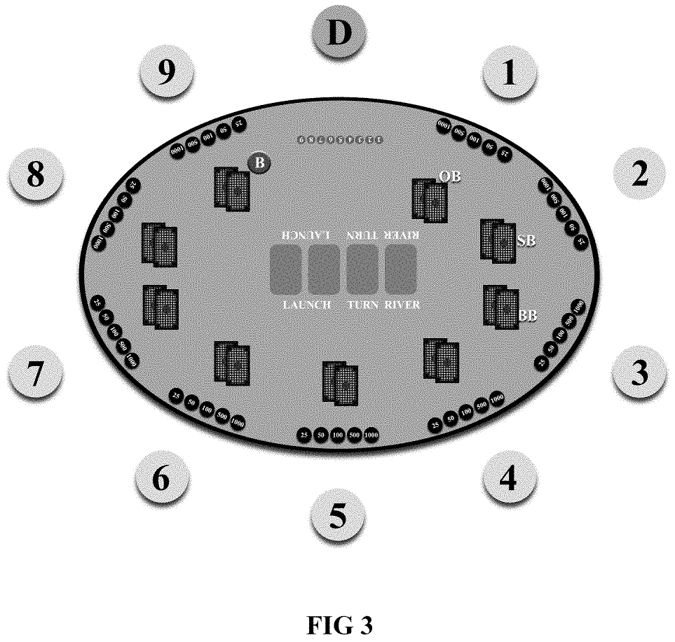

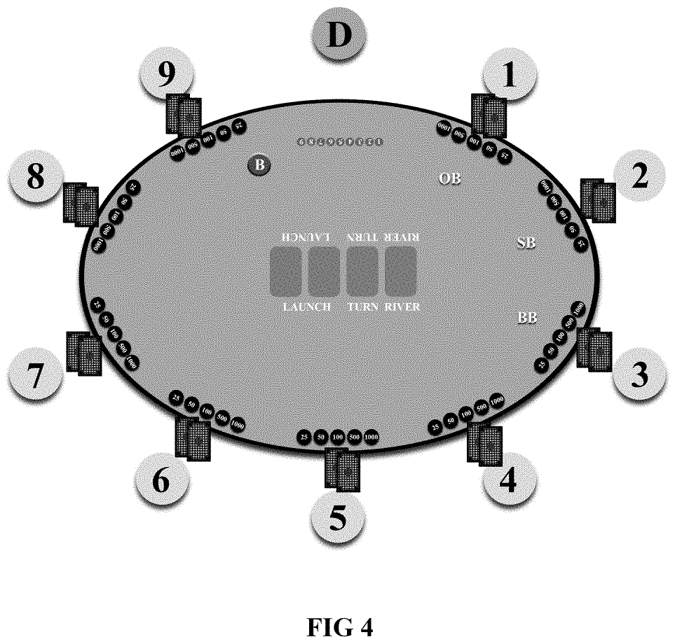

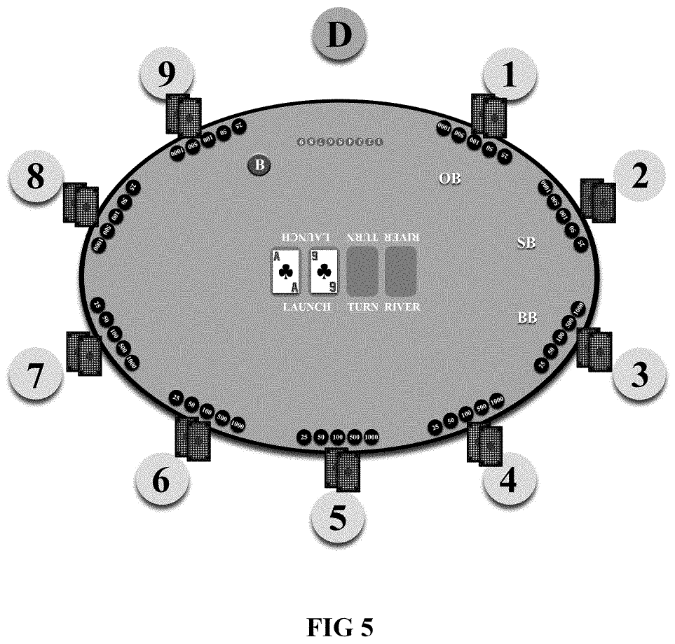

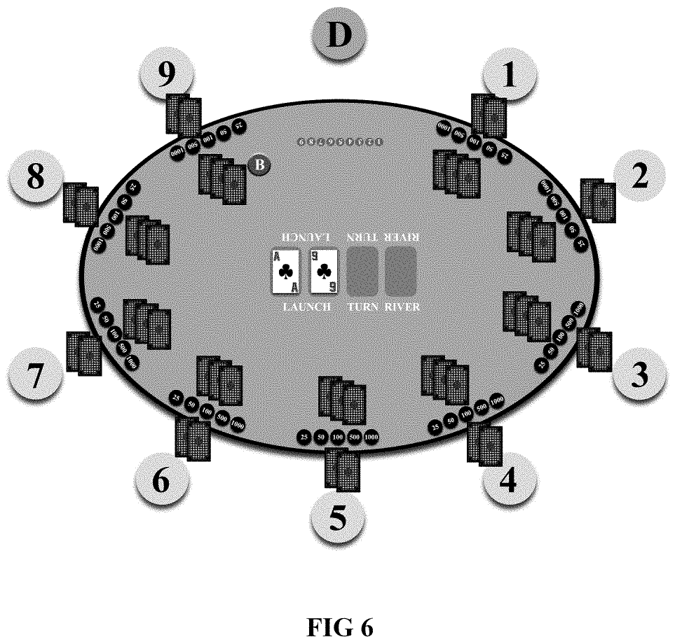

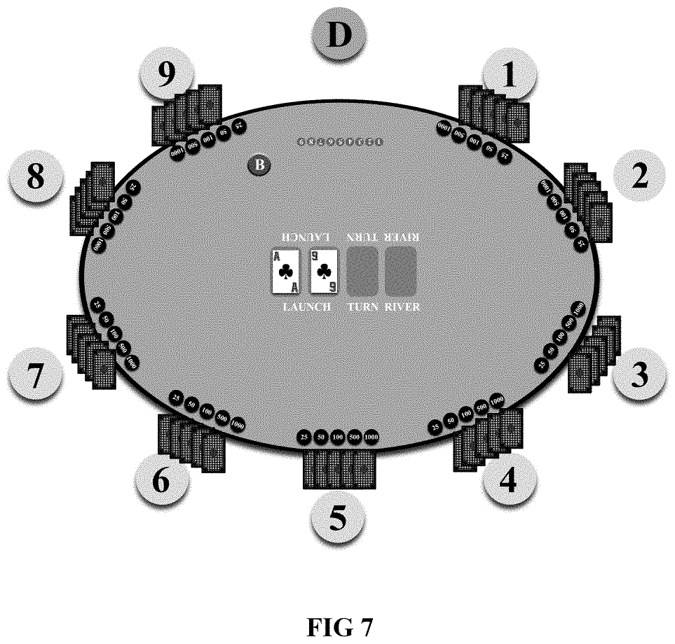

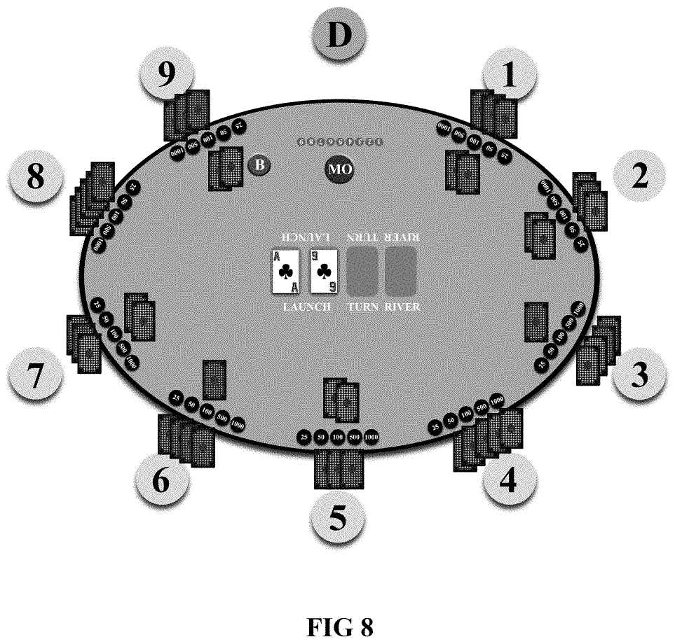

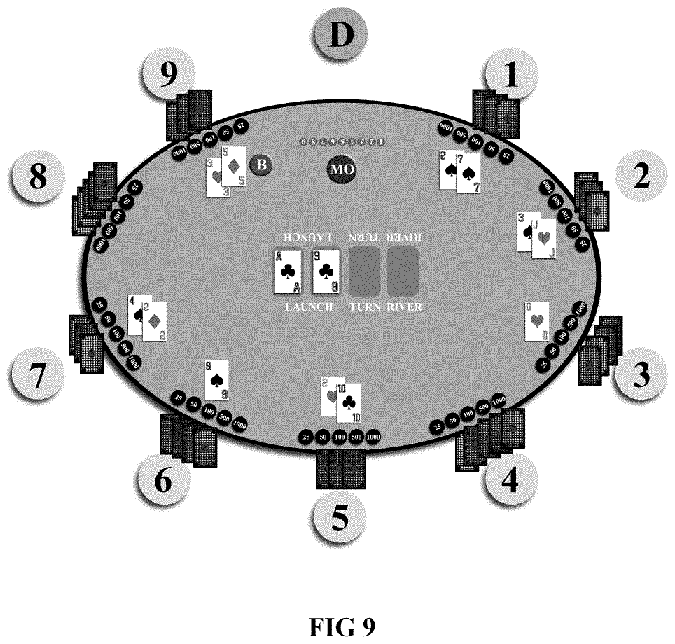

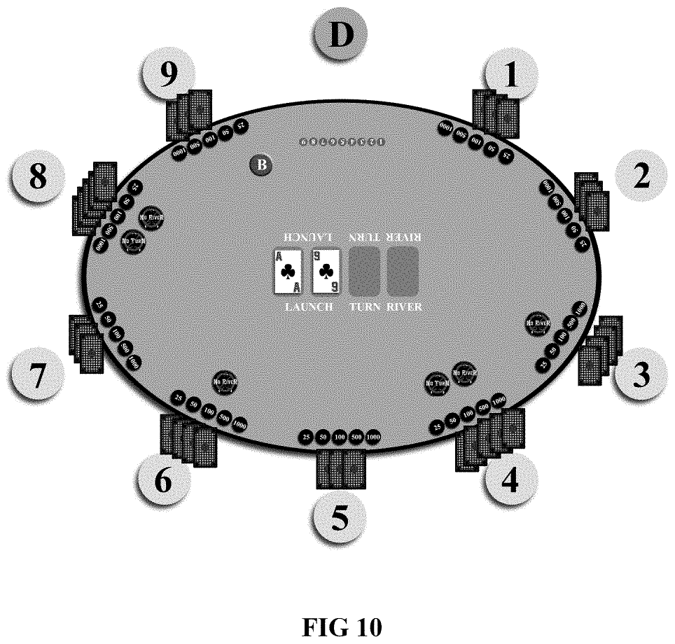

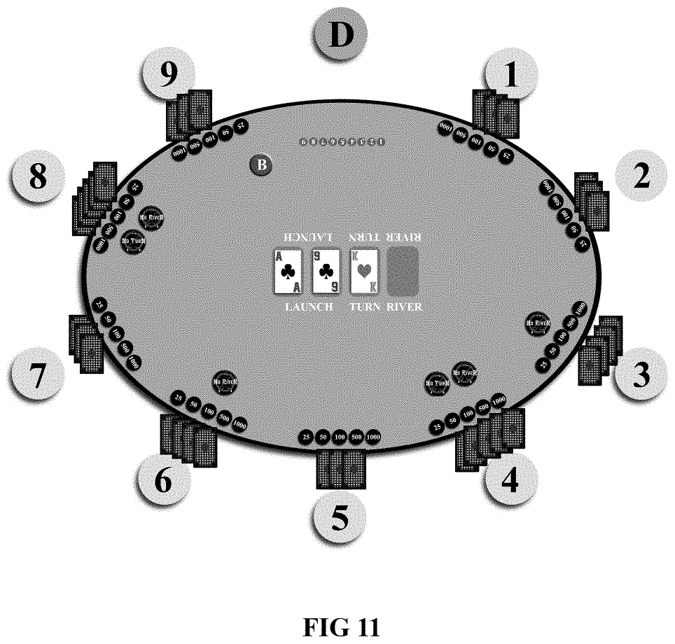

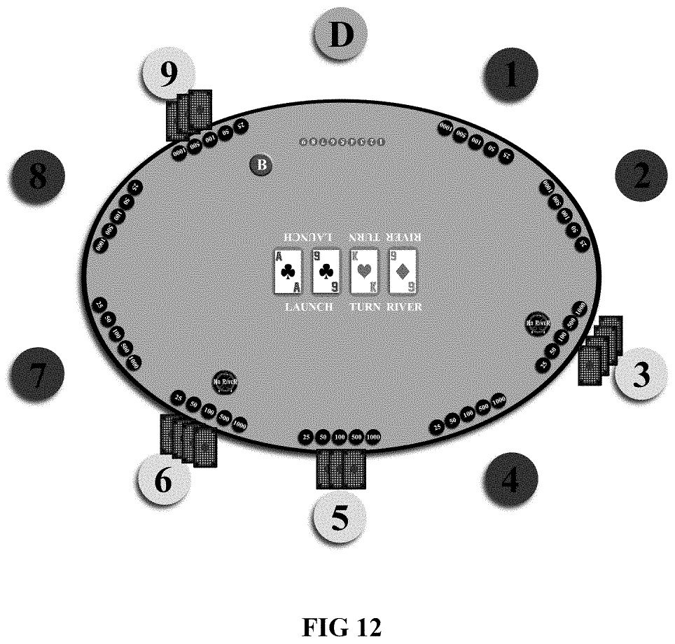

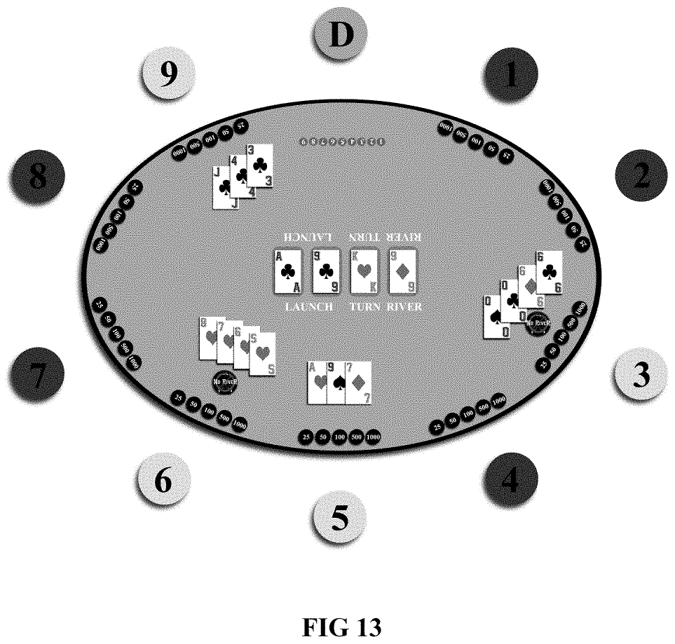

6: To avoid complex ‘side pot betting’ and deter ‘chip bullying’, during single Table or multiple Table Tournament play, an innovative method of chip distribution is employed, whereby any player who does not have enough chips to cover a bet or raises during a hand of the Tournament, will be credited with half the initial chip distribution in bonus chips, known as “Overdrawn Chips”, aka “ODC”, and in real world tournaments, the dealer places a red disc marker on the table by the corresponding seating position number (FIG. 1: Numbers 1-9) of any player who goes ‘all-in’ (runs out of chips) during any hand, or in any electronic versions, the player avatar turns red in color, and negative values record that player's actions, checking, seeing, betting or raising, depicted by a negative sign with red numerals by that player, with the rules governing the use of ODC as follows:
I. All players are entitled to “ODC”. At the “Showdown”, when ODC has been wagered and lost, it is added to the initial game chip total, boosting the chip count of the hand winner. If said player drawing Overdrawn Chips (ODC) wins that Hand, that player's ODC is returned to the “Bank” (overseen by the Dealer in a live Casino or Club, or programmed automatically in any electronic digital versions).
II. Thus, if the player drawing ODC wins the hand, said player is entitled to draw ODC in a subsequent hand. During any given hand, a player may only draw ODC once. Specifically, no further ODC will be issued to that player during said hand. The maximum total raises allowed, will be equivalent to the amount of ODC left in said overdrawn player's account, so when any player drawing ODC has less than 5 times the Big Blind in reserve chips left, the next player can only raise the amount that remains in the said player's ODC reserve. Subsequent players are permitted to see that player, and the last player to act calls said player, so that the player drawing and using all ODC reserve must reveal their hand first during the “Showdown”. In multiple Round table tournament play, chips won in previous Tournament Rounds, including ODC, are carried forward to the next Round.

7: To ensure that two players will have the opportunity to benefit from tournament winnings, a novel method of calculating winnings is claimed, whereby in a single Table Tournament of 3 to 9 players, when three players are remaining in the Tournament, if one player does not have enough chips to cover the bet or raises during any hand of the Tournament, that player must win that hand for tournament play to continue, so when the third player is eliminated, the Tournament ends, and the chip counts of both remaining players are each counted and totalled, whereby the winner's and runner-up's chip counts are divided by the total chip count to determine the proportional percentage of the Tournament Pot that will be awarded to the winner and runner-up, noting specifically that:
I. The winner is declared to be the player having the largest chip count and runner up is declared to be the player having the second largest (positive) chip count, but if the runner up has a negative chip count, the Tournament Pot is awarded to the winner.
II. Tournament Pot is, for example, defined as 0.9 multiplied by sum total (90%) of all Entry Fees, as typically, Tournament Licensee and Tournament Licensor will receive a total of ten percent (10%) of all Entry Fees.
III. In Multi-table tournament play as the number of players increase, small percentages will be awarded to lower placing players, reducing the Tournament Pot percentage, and that remaining percentage is split proportionally as set forth in claim 7.
IV. Charitable Donations: Tournament Pot multiplier coefficient of 0.90 (90%) is standard, but this coefficient may be decreased to 0.88, (88%) allowing 2% for charitable donations.

8: A novel method of marking a baize playing surface on a Poker table for use in Tennessee Hold 'Em® Tournaments in a casino, club, private tournament, or via any electronic device as a graphic representation is claimed, specifically as follows:
I. Four rectangles are marked in the centre of the table. The first two rectangles are labelled, “LAUNCH” and are positioned centrally to the right of the Dealer (and the left of the viewer, as seen in FIG. 1) and the second card distribution, two community cards known as ‘the Launch’, are placed face up within those rectangles;
II. The Third Rectangle is labelled, “TURN” and is positioned centrally, to the right of, and adjacent to the Launch, (as seen by the viewer in FIG. 1). The fourth card distribution is the third community card known as the ‘Turn’, which is placed face up within said rectangle;
III. The Fourth Rectangle is labelled, “RIVER” and is positioned centrally, to the right of, and adjacent to the TURN, (as seen by the viewer in FIG. 1). The fifth card distribution which is the fourth, final community card known as the ‘River’ is placed face up within said rectangle;
IV. These rectangles are labelled, LAUNCH, TURN, RIVER, both above and below the rectangle. As seen from all Figures these labels are positioned upside down to enable a clear view from both sides of the table, with the wording reversed, to correspond to the Labelling described previously. Specifically, the script is turned 180 degrees, and (as seen by the Dealer) starting from the Left, and it reads RIVER, TURN, LAUNCH (as seen in FIG. 1), so players sitting on both sides of the table can see the community card positioning.
V. In casinos or clubs, at 12 o'clock on the Table, as viewed in FIG. 1, nine shaded circles are labelled, 1 through 9, and these circles represent each player's seating position. When a player raises in any betting round, the dealer adds a counter, adjacent to the circle which corresponds to the player who is raising, to indicate the number of raises said player has made in that round of betting and in electronic versions each player's raises are recorded and shown automatically with a notification.
